(19) United States
(12) Patent Application Publication
(10) Pub. No.: US 2004/0122158 A1
(43) Pub. Date: Jun. 24, 2004

(54) Transparent aqueous coating agent containing glass powder

(76) Inventors: Rolf Kuropka, Selzen (DE); Thomas Fichtner, Dalheim (DE); Erich Gotz, Wunsiedel (DE)

Correspondence Address: MUSERLIAN AND LUCAS AND MERCANTI, LLP, 475 PARK AVENUE SOUTH, NEW YORK, NY, 10016, US

(21) Appl. No.: 10/472,902

(22) PCT Filed: Apr. 3, 2002
(86) PCT No.: PCT/EP02/03647

(30) Foreign Application Priority Data
Apr. 3, 2001 (DE) 101 16 604.4

(51) Int. Cl. C08K 3/40

(52) U.S. Cl. 524/494

(57) ABSTRACT

The present invention relates to transparent coating compositions based on aqueous synthetic resin dispersions, comprising at least one glass flour, to processes for preparing them, and to their use.

The present invention relates to a transparent coating composition based on an aqueous synthetic resin dispersion comprising at least one glass flour, preferably a borosilicate glass flour, to processes for preparing it, and to its use, preferably for the blocking-resistant, scratch-resistant, and UV-resistant coating of substrates, in particular of wood.

Aqueous transparent coating compositions on wood are formulated preferably on the basis of aqueous synthetic resin dispersions in combination with additives, such as, for example, solvents, rheology modifiers, transparent pigments, and preservatives. A disadvantage of these coating compositions is the UV sensitivity, which leads to rapid degradation of the coating composition on wood. Consequently it is common to add substances to such transparent coating compositions, such as, for example, HALS additives (HALS=hindered amine light stabilizer) or UV absorbers. These substances feature high efficacy. They are, however, very expensive. A further disadvantage of the known transparent coating compositions on wood is their thermoplasticity, as a consequence of the synthetic resin dispersions employed. As a result these transparent coating systems are difficult to sand, since as a result of the heat produced in the course of sanding the sandpaper very quickly sticks. A lack of blocking resistance may also represent a problem.

It is further known that glass is to be understood as being an inorganic melt product which solidifies without crystallising. The basic ingredients, network former and network modifier, are in oxide form in the case of the most commonly used glasses. Typical glass formers (network formers) are silica (SiO₂), boric acid (B₂O₃), phosphoric acid (P₂O₅), and, under certain circumstances, alumina (Al₂O₃) as well. These materials are capable of taking up (dissolving) metal oxides up to certain fractions without losing the vitreous character. The incorporated oxides, therefore, are not involved in forming the glass, but as “network modifiers” modify certain physical properties of the glass structure. Below a wavelength of about 310 nm the transmission of glasses is virtually 0, i.e. UV rays, especially “hard” UV rays, which cause severe damage to polymer films and/or the underlying wood, are adsorbed.

From JP-A-02 196 874 it is known that borosilicate glasses can be used in combination with a thickener and an emulsifier to produce heat-resistant and fire-resistant coatings.

From JP-A-58 037 962 it is known that borosilicate glasses can be used in combination with silicone resins or polyester resins to produce heat-resistant coatings on glass.

Known from JP-A-07 062 272 are transparent inorganic coatings based on borosilicate glasses, to which an antibacterial or antifungal quality is imparted through the addition of silver salts.

Glass flours are produced by corresponding grinding operations from recycled glass and industrial waste, and in accordance with their origin are referred to, for example, as float glass flours, borosilicate glass flours or quartz glass flours.

Surprisingly it has now been found that the addition of glass flours, preferably borosilicate glass flours, to aqueous woodstains based on synthetic resin dispersions with or without additives markedly improves the UV resistance, sandability, and blocking resistance.

The present invention accordingly provides a transparent coating composition based on an aqueous synthetic resin dispersion comprising at least one glass flour, preferably a borosilicate glass flour.

It is preferred to use glass flours which have no significant effect on the transparency of the coating.

The aqueous synthetic resin dispersion may if desired include customary UV-adsorbing additives. Preferably, however, the coating composition of the invention contains no such additives, since the glass flours are used instead of them.

All know glass flours are suitable in accordance with the invention. Examples of suitable glass flours which are available commercially include borosilicate glass flour 3.3 and borosilicate glass flour 4.2 from Ziegler & Co., Wunsiedel, Germany. Mixtures of these borosilicate glass flours are also suitable.

An important factor is the fineness of grind of these glass flours. This parameter is frequently determined by the Cilas curve. Preferred average particle sizes lie in the range from 1 to 200 μm, with particular preference in the range from 5 to 50 μm. The desired properties are exhibited by the transparent coating composition, however, even when other borosilicate glass flours are present.

In comparison to commonplace quartz glass flours, borosilicate glass flours also bring about a marked improvement in sandability.

The glass flour is present in the coating composition preferably in an amount of from 0.5 to 50% by weight, with particular preference from 1 to 30% by weight, and in particular from 3 to 15% by weight, based on the aqueous synthetic resin dispersion.

The present invention also provides a process for preparing the coating composition of the invention. This process comprises adding at least one glass flour to the aqueous synthetic resin dispersion.

The coating compositions of the invention are used in particular in coating materials with high UV stability, blocking resistance, and sandability.

They likewise find use as UV-resistant, blocking-resistant, and readily sandable coatings.

The invention is described in more detail below with reference to working examples, though without being restricted thereby.

A variety of coating compositions are prepared. Quartz glass flour and/or borosilicate glass flour is added to the coating composition, and its effect on the UV permeability and on performance properties, such as blocking resistance and sandability, for example, is tested. The preparation and testing are described in detail.

### EXAMPLE 1

Preparation of a Test Stain Without Addition of a Glass Flour (Comparative Coating):

Base formula of the inventive woodstain and comparative stain:

| Constituents | Parts by weight |
|---|---|
| Synthetic resin dispersion (acrylate/styrene; solids | 740.0 |
| content: 50% glass temperatures 2° C./90° C.) | |
| Ammonia, 25% | 2.0 |
| Water | 108.5 |
| Preservative (isothiazolinone) | 2.0 |
| Flatting agent (silica) | 15.0 |
| Defoamer (mineral oil-based) | 4.0 |
| Dispersant (polyacrylate) | 3.0 |
| Film-forming auxiliary (glycol ether) | 20.0 |
| Film-forming auxiliary (alkoxyl alcohol) | 20.0 |
| Thickener (xanthan-based) | 0.5 |
| Thickener (polyurethane) | 5.0 |
| Slip agent (wax emulsion) (or lubricant) | 40.0 |
| | 960.0 |

### EXAMPLES 2 TO 5 AND 10

Production of Inventive Transparent Coatings by Addition of Quartz Glass Flours:

| | Parts by weight of borosilicate |
|---|---|
| | glass flour (max. 82.8% SiO₂, |
| | min. 10% B₂O₃, 2% Al₂O₃, |
| | 0.5% K₂O, 3.7% Na₂O |
| Woodstain | Average particle size 25 μm |
| Woodstain 2 | 10 |
| Woodstain 3 | 30 |
| Woodstain 4 | 50 |
| Woodstain 5 | 100 |
| Woodstain 10 | 300 |

### EXAMPLES 6 TO 9 AND 11

Production of Inventive Transparent Coatings with Addition of 1% by Weight, 3% by Weight, 5% by Weight or 10% by Weight of Borosilicate Glass:

| | Parts by weight of quartz |
|---|---|
| | glass flour (99.7% SiO₂, |
| | 0.15% Na₂O, |
| | 0.15% K₂O) |
| Woodstain | Average particle size 20 μm |
| Woodstain 6 | 10 |
| Woodstain 7 | 30 |
| Woodstain 8 | 50 |
| Woodstain 9 | 100 |
| Woodstain 11 | 300 |

For testing of the blocking resistance, films of the comparative coating (example 1) and of the inventive coatings (examples 2 to 9) are knife coated with a slot height of 50 μm onto a non-absorbent support material. After drying, the test specimens are pressed against one another over an area of 6.5 cm². The duration and temperature of loading is set out in the table below. Thereafter the test specimens are separated from one another mechanically. The weight force required is a measure of the blocking.

The compilation of the results is shown by the following table:

Blocking [g/6.5 cm²]

| | Drying 1 day | Drying 2 days |
|---|---|---|
| Woodstain | Loading 2 hours at RT | 1 hour at 50° C. |
| Woodstain 1 | 240 | >2000 |
| Woodstain 2 | 230 | >2000 |
| Woodstain 3 | 220 | 1830 |
| Woodstain 4 | 210 | 1400 |
| Woodstain 5 | 200 | 1070 |
| Woodstain 6 | 230 | >2000 |
| Woodstain 7 | 210 | 1700 |
| Woodstain 8 | 200 | 1570 |
| Woodstain 9 | 180 | 1120 |

For testing the sandability both the transparent comparative dispersion (example 1) and the inventive transparent coatings (examples 2 to 9) are knife coated with a slot height of 200 μm onto a glass plate. After a drying time of 3 days at room temperature the surfaces of the coatings are sanded with a commercially customary 360-grade sandpaper. Sandability is good if the sandpaper does not stick during sanding.

| | Sandability |
|---|---|
| Woodstain | (1 = very good; 6 = inadequate) |
| Woodstain 1 | 4 |
| Woodstain 2 | 4 |
| Woodstain 3 | 4 |
| Woodstain 4 | 3 |
| Woodstain 5 | 2 |
| Woodstain 6 | 4 |
| Woodstain 7 | 4 |
| Woodstain 8 | 4 |
| Woodstain 9 | 4 |

To test the transmission, three films of the woodstains 1 to 9 are produced with a knife coater with a slot height of 50 μm and 200 μm. The transmission is determined using the Cary 1 G from Varian in a range from 190 nm to 900 nm. The inventive woodstains 2 to 9 exhibit a marked reduction in transmission as compared with woodstain 1 (comparative).

1. A transparent coating composition based on an aqueous synthetic resin dispersion, comprising at least one glass flour, wherein the glass flour is a borosilicate glass flour.

2. The coating composition as claimed in claim 1, wherein the glass flour has an average particle size in the range from 1 to 200 μm.

3. The coating composition as claimed in claim 1 or 2, wherein glass flour is present in an amount of from 0.5 to 50% by weight, based on the aqueous synthetic resin dispersion.

4. A process for preparing a coating composition as claimed in claim 1, which comprises adding at least one glass flour to the aqueous synthetic resin dispersion.

5. The use of a coating composition as claimed in claim 1 in a coating material with high UV stability, blocking resistance, and sandability.

6. The use of a coating composition as claimed in claim 1 as a UV-resistant, blocking-resistant, and readily sandable coating.
